(19) United States
(12) Patent Application Publication
(10) Pub. No.: US 2025/0000741 A1
(43) Pub. Date: Jan. 2, 2025

(54) MEHANIZED PHALLIC DEVICE WITH SYNCHRONIZED CHANGE IN STATE AND ACTION

(71) Applicant: WEB FOX TECHNOLOGY, LLC, St. Pete Beach, FL (US)

(72) Inventor: Vivien Cambridge, Myrtle Beach, SC (US)

(73) Assignee: WEB FOX TECHNOLOGY, LLC, St. Pete Beach, FL (US)

(21) Appl. No.: 18/690,522

(22) PCT Filed: Sep. 9, 2022
(86) PCT No.: PCT/US2022/043039

§ 371 Date: Mar. 8, 2024

Related U.S. Application Data
(60) Provisional application No. 63/242,280, filed on Sep. 9, 2021.

(51) Int. Cl. A61H 19/00

(52) U.S. Cl. CPC A61H 19/44; A61H 2201/0119; A61H 2201/1215; A61H 2201/1246; A61H 2201/1669; A61H 2201/5012; A61H 2201/5043; A61H 2201/5097

(57) ABSTRACT

A system is presented for use in masturbation wherein the states, movement and climactic action of a simulated phallic object are related to the states, movement and climactic action of a phallus depicted in associated media, such as video, images, software, gaming, etc. The system is provided where the morphological state and position of a simulated male sex organ varies over time in synchrony with a corresponding male sex organ depicted in associated media such that the simulated male sex organ dispenses a fluid that relates to climax of a male sex organ in the associated media.

### CROSS REFERENCE TO RELATED APPLICATION

This application claims priority to U.S. Provisional Patent Application 63/242,280, filed on Sep. 9, 2021, the entire contents of which is hereby incorporated by reference as if fully set forth herein.

### FIELD OF INVENTION

The present disclosure is related to mechanized female masturbation devices. More specifically, the present disclosure provides a system where the morphological state and position of a simulated male sex organ varies over time in synchrony with a corresponding male sex organ depicted in associated media such that the simulated male sex organ dispenses a fluid that relates to climax of a male sex organ in the associated media.

### BACKGROUND OF THE INVENTION

The process of masturbation has well-documented benefits for the human mind and body including the relief of stress, possible prevention of cervical and urinary tract infections and prostate cancer, improved cardiovascular health, reduced risk of type 2 diabetes, reduction in insomnia and more. The regular use of penetrative masturbatory implements that include soft, flesh-like, phallic shaped silicone may also boost vaginal lubrication, blood flow to the vagina, and elasticity of the tissues, all of which make for better, more pleasurable sex and heightened libido and a reduction in sexual dysfunction during coitus. These implements can also have the tactile properties of the sexual organs of a sexual partner and therefore enhance the success of the masturbation process.

Many current day female masturbation devices are mechanized and some devices of the current art are mechanized where motors mimic the normal thrusting motion during sex. Devices of the current art simply turn on and off an actuating mechanism and speed up or slow down the movement under user control.

Existing mechanized devices for receiving a male penis can provide a link to a computer system or network whereby the motion of the massaging mechanism can be controlled by software related to games or movies or related to remote users with or without devices. For example, U.S. Pat. No. 8,378,794 B2 describes an apparatus for generating sensations in response to haptic data wherein an output device is connected to a processor which generates control signals corresponding to certain haptic commands. The output device comprises an actuator adapted to output a force to a drive mechanism in response to the control signals received from the processor. U.S. Pat. No. 8,378,794 B2 discloses a device having an opening through which a portion of a male's body, such as the penis, can be inserted, and an “interface surface” coupled to the drive mechanism. As disclosed in U.S. Pat. No. 8,378,794 B2, the interface surface, which is made of a soft rubber material, contacts the inserted portion of the male user's body. The interface surface is actuated under control of the processor which relates the movements of the interface surface to media displayed to the user where the movements of the interface surface are correlated with action displayed in the media.

The haptics sensations imparted to the user synchronized with the video displayed to the user heightens the pleasure experienced by the user. Users of such devices can experience a physical sensation that is synchronized with or otherwise related to actions displayed in movies or games. There are important and fundamental differences in the male and female reproductive systems and therefore the modes and function of masturbatory devices used by the sexes varies. For example, a device used by a male user can include an actuated elastomeric substance that moves relative to his organ as the organ is inserted in the substance. Conversely, the system and mechanism for use by a female would mimic the states and movement of a male partner.

Unlike the simulated female sex organ, the simulated male sex organ changes substantially in shape and hardness in the course of sex, and the male sex organ thrusts until ejaculating during the climax. There is a need for a device that correlates a simulated male sex organ used by a female user to an actual male sex organ depicted in multimedia.

### SUMMARY OF THE INVENTION

In one example, a mechanized masturbatory device is disclosed herein that mimics and synchronizes its state, location and actions with the morphological properties, the location, and the ultimate ejaculation of the male sex organ depicted in media.

The present disclosure provides a system and device comprising a phallic body which progresses through states of arousal, thrusts and ultimately dispenses ejaculate. These states, movements and climax action are related to states, movement and climax action presented in associated media.

The present disclosure is related to mechanized female masturbation devices. More specifically, the present disclosure provides a system where the morphological state and position of a simulated male sex organ vary over time and is synchronized with a corresponding male sex organ depicted in associated media, which may be an associated video stream comprising imagery, such as a movie clip or rendered depictions of objects in a virtual reality or 3D world or which may be an audio stream, and where the simulated male sex organ dispenses a fluid related to the climax of a male sex organ in the associated media.

According to a first aspect, the present application is directed to a phallic masturbation device which comprises a phallic member that is actuated, moves and changes shape under control of a processor which relates the movements and state of the phallic member so that these movements and state are synchronized with movement and state depicted in associated media.

It is a second aspect of the present disclosure that the phallic member includes means for mimicking in a synchronized way the climactic actions depicted in associated media, which can include ejection or dispensing of liquid.

According to a third aspect of the present application, the phallic masturbation device can comprise a phallic member which is actuated, moves and/or changes shape under control of a processor which is configured to associate the movements and state of the phallic member of a remotely located live partner in video communication with the user of the device of the present invention.

In a fourth aspect of the present invention, the phallic member of the device can include means for mimicking in a synchronized way the climactic actions of a remotely located live partner in video communication with the user of the device.

Additional embodiments are disclosed herein.

### BRIEF DESCRIPTION OF THE DRAWINGS

The foregoing Summary and the following Detailed Description will be better understood when read in conjunction with the appended drawings, which illustrate a preferred embodiment of the invention. In the drawings:

FIG. 1 illustrates a first embodiment of the present disclosure.

FIG. 2 illustrates exemplary components of the device of the first embodiment.

FIG. 3 illustrates a phallic body and associated mechanism according to one example of the present disclosure.

FIGS. 4A-4D illustrate various states of use for a phallic body according to some examples.

FIG. 5 illustrates a flowchart of one aspect of the present disclosure.

FIG. 6 illustrates a second embodiment of the present disclosure.

FIG. 7 illustrates a flowchart associated with use of the system of the second embodiment.

### DETAILED DESCRIPTION

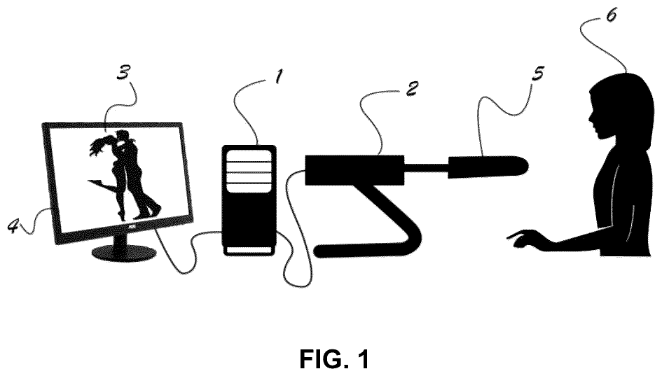

As shown in FIG. 1, a first embodiment of the present disclosure can comprise a masturbatory device 2 for use by a user 6 that includes a phallic body 5 (i.e. a sex toy) which can be configured to move, change shape, and/or perform certain action. A processor 1 can be configured to control these actions of the phallic body 5. The processor 1 can be configured to provide media 3 (i.e. moving pictures, images, videos, gaming software, audio, etc.) to the user 6 via a monitor or display 4. The processor 1 can be configured to associate, relate, or synchronize the state, location and/or physical action of the phallic body 5 to the state, location and/or physical action of a corresponding male organ (i.e. phallus) depicted in media 3. The processor 1 can be integrated into a CPU, smart phone, or other electronic device. The masturbatory device 2 can include a support or stand and can be connected to the processor 1 and the phallic body 5. A control assembly is generally provided that includes a plurality of specific components to carry out manipulation, movement, etc., of the phallic body 5, such as syringes, motors, screws, nuts, arms, etc.

The phallic body 5 can comprise an elastomeric silicone material that is elastic and that is configured to surround a container 20 (i.e. an elastic or rubber bag or container) which can be configured to expand and contract a fluid or other material inside the container 20. The fluid within the container 20 can be increased or withdrawn. As fluid inside the container 20 is increased or withdrawn, the container 20 can be configured to either become more rigid and harden, or become softer and more flaccid.

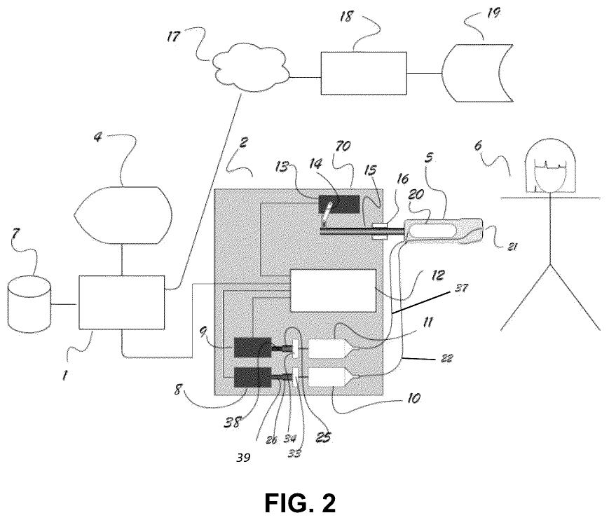

As shown in FIG. 2, a housing 70 can be provided that is configured to enclose a processor 12 which is configured to control a control assembly, as well as other aspects of the masturbation device. The control assembly can include, among other components, a plurality of drivers or motors, such as motor 13 (i.e. servo motor), a first DC motor 9 and a second DC motor 8. The processor 12 can include various electrical components, and can include a controller that is configured to receive and send signals in order to drive or control other components, such as a motor. The servo motor 13 can be configured to move or swing at least one arm 14 which pushes a push rod 15, which can both be components of the control assembly. The push rod 15 can be supported via a bearing or other support 16 relative to the housing 70. The push rod 15 can be configured to protrude from the housing 70 and connects with the phallic body 5 such that the servo motor 13, which is controlled via the processor 12, controls the excursion and reciprocating motion of the phallic body 5.

The control assembly can also include a first DC motor 9 configured to rotate under control of the processor 12 to turn a lead screw 38 which is configured to move a lead screw nut 25 so that the lead screw nut 25 moves a plunger 34. As the plunger 34 moves forward, fluid in a syringe 11 moves through conduit 37 to the container 20 which can be an expandable rubber bag such that the firmness and size of the container 20 changes depending on the amount of fluid in the container 20.

Also, as the processor 12 causes fluid in the syringe 11 to move into container 20, the container 20 can be configured to expand and harden. When the container 20 expands and hardens, the elastomeric silicone that surrounds the container 20 can be configured to expand and harden as well.

A support or stand element 36 can also be provided that is configured to support the masturbatory device 2.

Accordingly, the state of the phallic body 5 can be configured to transition from flaccid to erect under control of the processor 12, and in order to mimic the state of a phallus in associated media. The processor 12 can be configured to control operation of the second DC motor 8 which is configured to rotate a lead screw 39 so that the lead screw 39 causes a lead screw nut 26 to move a plunger 33 such that liquid in a syringe 10 moves through a conduit 22 through the phallic body 5 to at least one opening 21 defined on the phallic body 5, whereby fluid squirts from the at least one opening 21 of the phallic body 5 to stimulate climax. The syringe 10, and associated lead screw and nut, plunger, etc. can also be consider components of the control assembly.

According to one aspect of the present disclosure, a system of the present disclosure includes a processor 1 which is configured to access video data on data storage unit 7 and which includes software configured to display video data on monitor 4 while the processor 1 transmits data to the device processor 12 which causes the device processor 12 to move, change the state of, or change the action of the phallic body 5 in accordance with media, audio, images, or video, etc. displayed on the monitor 4 such that a user 6 of the device experiences the thrusting motions, the morphological transformations and the climactic ejaculation action through the phallic body 5 which are synchronized with the movement, state and action of a male organ or phallus displayed in video on monitor 4.

According to another aspect, a server 18 can be provided which is configured to access a data storage unit 19 which can be configured to store encoded video data. The server 18 can be configured to transmit encoded video data through a cloud, remote data server, or other type of internet connection 17 to the processor 1. This data can be associated with the state of motion, hardness, etc. of a phallus.

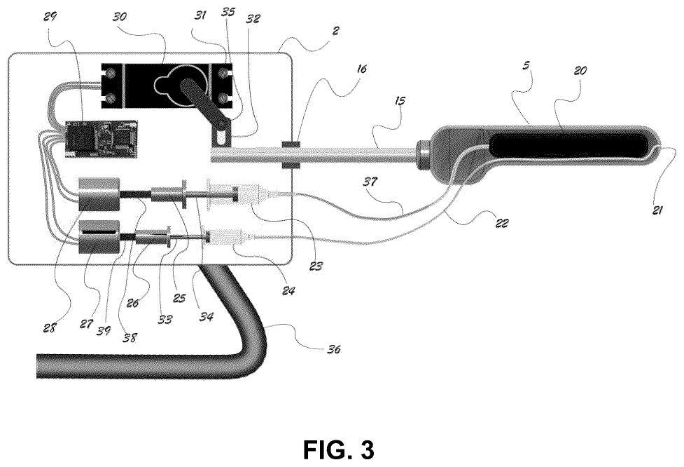

FIG. 3 is an illustration showing a cutaway view of the phallic body 5 and the associated components. The phallic body 5 can be comprised of a stretchable soft elastomeric silicone that is capable of expanding the container 20 that is arranged within the phallic body 5. The container 20 is configured to be filled and pressurized with fluid, and the container 20 hardens and swells and the phallic body 5 is similarly controlled to change its state. When the container 20 fills with fluid, the shape and state of phallic body 5 changes from flaccid to erect.

The processor 29 can be configured to control a first DC motor 28 which can be configured to turn or rotate a lead screw 38 so that the lead screw 38 moves or drives a lead screw nut 25 which pushes a plunger 34 within a syringe 23 so that fluid in the syringe 23 is forced into the container 20 the container 20 to expand and harden.

The phallic body 5 can further include at least one opening 21 through which fluid travels via conduit 22 from a syringe 24. Liquid is forced from the syringe 24 by a plunger 33 which is actuated through a lead screw nut 26. The lead screw nut 26 can be configured to be moved or driven when a lead screw 39 is rotated by a DC motor 27 which is controlled by the processor 29 to cause dispensation of fluid from the phallic body 5.

The processor 29 can be configured to control a servo motor 30 which is configured to move or swing at least one arm 31 to change a location of a bar 35 which moves a scotch yoke slotted arm 32 causing the slotted arm 32 to move in the direction along the main axis of phallic body 5, thereby controlling or changing the excursion of phallic body 5 under control of the processor 29 such that excursion, morphological state and climactic action of the phallic body 5 are synchronized with media, such as video, showing a phallus and displayed to user of the device.

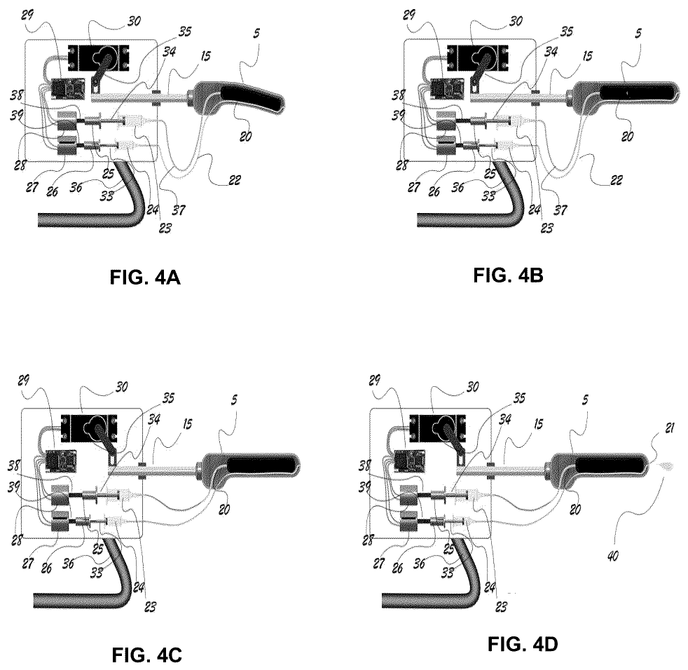

FIGS. 4A-4D illustrate the progressive states of the phallic body 5. FIG. 4A shows that fluid in the container 20 is initially low and the container 20 is smaller in size and relaxed. As a result, the appearance of phallic body 5 is flaccid.

As shown in FIG. 4B, the processor 29 controls first DC motor 28 to rotate, which causes the lead screw 38 to rotate thereby moving the lead screw nut 25 forward. As a result, the plunger 34 empties the syringe 23 so that fluid moves into container 20 through conduit 37, which causes container 20 to harden and which changes the appearance and tactile properties of the phallic body 5 which now appears erect.

In FIG. 4C, the processor 29 controls the servo motor 30 to engage the bar 35 so that bar 35 swings and pushes the push rod 15 which in turn pushes the phallic body 5 through a sequence of excursions causing thrusting motion of the phallic body 5.

Finally, as shown in FIG. 4D, the processor 29 controls the second DC motor 27 to rotate such that the lead screw 39 rotates thereby driving the lead screw nut 26 and pushing the plunger 33 into the syringe 24 which causes liquid in the syringe 24 to pass through conduit 22 and through the at least one opening 21 of phallic body 5 thereby spraying or releasing the simulated ejaculate 40 from phallic body 5 during climax.

The processor 29 can be configured to control states of the phallic body 5 in conjunction with the processor 1 such that the states, movement and action of the phallic body 5 are synchronized with media 3 displayed to the user 6.

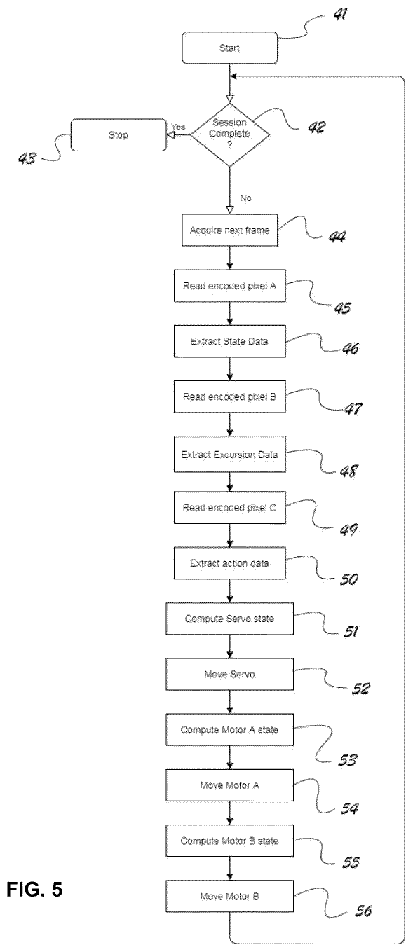

FIG. 5 shows a flow chart that illustrates one series of steps or processes of the present disclosure. As shown in FIG. 5, the system starts at step 41 and determines if a session is complete at step 42. If a session is not complete, then the system acquires video frame data at step 44 and reads from image data, such as a video frame encoded pixels, from the video frame.

According to one aspect, each video frame can contain a first patch of image in the upper left corner which comprises one or more pixels having an intensity between 0 and 255, which relate to state of the phallic body. In one example, the value 0 corresponds to black and the value 255 corresponds to white.

As shown in FIG. 5, step 45 includes reading encoded pixel A from a first patch and converting an intensity of encoded pixel A to state data in step 46. In one example, each video frame contains a second patch of image in the upper left corner which comprises one or more pixels having an intensity between 0 and 255, which relates to excursion of the phallic body.

Step 47 can include reading encoded pixel B from the second patch and converting the intensity of encoded pixel B to extrusion data in step 48.

In one example, each video frame contains a third patch of image in the upper left corner which comprises one or more pixels having an intensity between 0 and 255 which relates to ejaculation action of the phallic body.

Step 49 can include reading an encoded pixel C from the third patch and converting an intensity of encoded pixel C to ejaculation action data in step 50.

In step 51, the system can be configured to compute or detect a servo motor state and the move the servo motor to the desired position commensurate with the current excursion in step 52.

In step 53, the system can be configured to compute or detect the state of a first DC motor (i.e. Motor A) and the system can be configured to move the first DC motor to the desired position commensurate with the state of phallic body in step 54.

In step 55, the system can be configured to detect or compute a state of a second DC motor (i.e. Motor B) and the system proceeds to move the second DC motor to a desired position commensurate with ejaculation action in step 56.

The system then returns to step 42. If the session is complete, the system ends the process in step 43.

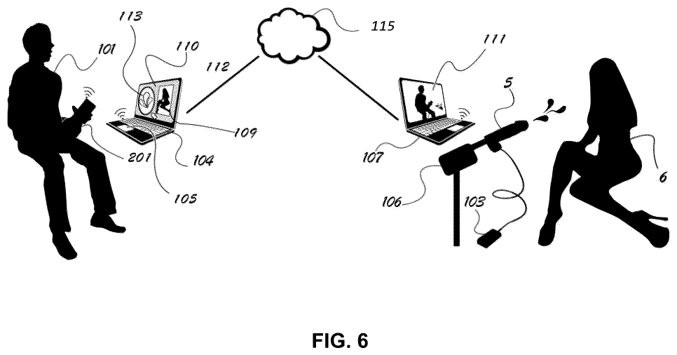

As shown in FIG. 6, a second embodiment of the present disclosure is provided that includes a masturbatory device 106 for use by a user 6 that includes a phallic body 5 which moves, changes shape and performs certain action under control of a processor 107 which is configured to provide or transmit video to display 111. In one aspect, the video displayed on the display 111 is video that is recorded and transmitted by a remote processor 104 associated with a second user 101. The processor 104 can be connected to a video recorder or image recorder (i.e. webcam or camera) which records video of the second user 101. The second user 101 can control the state, location and physical action of phallic body 5 through a connected masturbator device 201 which senses and modulates data related to use of the masturbator device 201. This data is transmitted to the processor 104 and subsequently transmitted through a network 115 to the processor 107.

In addition to said data generated and modulated in relation to use of masturbator, the remote processor 104 can be configured to execute software which displays a user interface component such as a button 113 which can be selectively clicked or engaged by the user 101, such as via a mouse pad 105 or other user interface. Engaging the button 113 can send data related to the desired state and action of the phallic body 5, which may correspond to a degree of erection and/or ejaculation. A window or other visual element 109 can be provided on the display 110 for showing the first user 6.

The phallic body 5 can comprise an elastomeric silicone material that is elastic and that surrounds the container 20 which is configured to expand and contract as a fluid inside the container 20 is increased or withdrawn. As fluid inside the container 20 is increased or withdrawn, the container 20 hardens and softens accordingly. As also shown in FIG. 6, a data connection line 112 can be provided between the processors and the network 115. In example, a housing 103 can be provided that is configured to hold or contain components of the control assembly, such as motors 8, 9, 27, 28 and syringes 10, 11, 23, 24. The housing 103 can be optional, and instead all of the components can fit within the masturbation device housing.

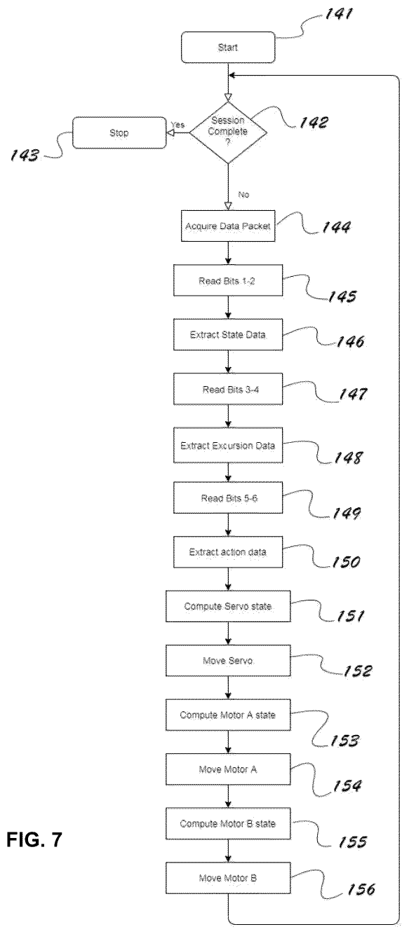

FIG. 7 shows a flow chart of one aspect of the present disclosure. As shown in FIG. 7, the system starts at step 141 and is configured to determine if the session is complete at step 142. If the session is not complete, the system acquires and/or transmits a data packet from a remote processor (i.e. processor 104) to a local processor (i.e. processor 107) in step 144 and parses the data packet to extract bits.

According to one example, a transmitted data packet can comprise first bits 1 and 2, which can be read or analyzed at step 145. The processes disclosed herein can be configured to convert first bits 1 and 2 to state data in step 146. In one example, the term bit is used as a basic unit of information that makes up a data packet, wherein each bit represents a value of 0 or 1.

Next, a second group of bits, i.e. bits 3 and 4, which can be related to excursion of the phallic body, can be read or analyzed at step 147. After this step, bits 3 and 4 can be extracted during step 148.

Next, a third group of bits, i.e. bits 5 and 6, which can relate to ejaculation action of the phallic body, can be read or analyzed at step 149.

Step 150 can include extracting action data related to bits 5 and 6. In step 151, the system can be configured to compute or determine a servo motor state and the system can be configured to drive or control the servo motor to the desired position commensurate with a current excursion in step 152.

In step 153, the system can be configured to determine or compute a state of a first DC motor (i.e. Motor A) and the system can be configured to drive or move the first DC motor to the desired position commensurate with the state of phallic body in step 154.

In step 155, the system can be configured to compute or determine the state of a second DC motor (i.e. Motor B) and the system proceeds to move, drive, or control the second DC motor to the desired position commensurate with ejaculation action in step 156.

The system then returns to step 142. If the session is complete, the system ends the process in step 143.

A masturbation device is disclosed herein that includes a phallic body 5. A control assembly is also provided that is configured to control the phallic body 5. The control assembly can include a variety of components, such as the mechanisms for adjusting or controlling the displacement and movement of the phallic object 5, as well as the syringes, lead screws and nuts, plungers, and motors for controlling the amount of fluid provided to the phallic body 5. A processor (such as processor 12, 29) is configured to control the control assembly and configured to receive data related to movement of a phallus displayed in media, such as in a video, gaming software, images, etc. Movement of the phallic body 5 can correspond to movement of the phallus displayed in the media.

The control assembly can include a container 20 arranged inside of the phallic body 5 that is configured to adjust a rigidity of the phallic body 5. The control assembly can further include at least one first syringe (such as syringes 10, 23) configured to selectively provide fluid to the container 20 such that rigidity of the phallic body 5 is adjustable based on a volume of fluid within the container 20. The control assembly can further include at least one second syringe (such as syringes 11, 24) configured to provide fluid to at least one opening 21 defined on the phallic body 5.

The control assembly can be configured to provide input signals to: (i) a first motor (such as motor 9, 28) associated with the at least one first syringe, (ii) a second motor (such as motor 8, 27) associated with the at least one second syringe, and (iii) a third motor (such as motor 13, 30) associated with at least one arm configured to control movement of the phallic body 5.

A housing can be configured to surround the first motor, the second motor, the third motor, the at least one first syringe, and the at least one second syringe. A respective lead screw and nut assembly 25, 26, 38, 39 and a plunger 33, 34 can be associated with each of the syringes 10, 11, 23, 24.

The control assembly can be further configured to at least adjust: (i) rigidity of the phallic body 5; and (ii) dispensing of fluid from the phallic body 5.

The data related to movement of the phallus displayed in media can be transmitted via a secondary processor (such as processor 1) to the device processor (such as processor 12). The processors 1, 12 can be connected to a monitor 4 that is configured to display the phallus.

The phallic body 5 can be formed from an elastomeric silicone material, in one example.

A masturbation device is also disclosed herein that includes a phallic body; a control assembly configured to control the phallic body; and a processor configured to control the control assembly, wherein the processor is configured to receive input data from a remote user. Movement of the phallic body can correspond to movement associated with the input data from the remote user, and hardness of the phallic body can be adjusted based on the input data.

A method of controlling a masturbation device is also disclosed herein that includes: (i) adjusting a rigidity of a phallic body of the masturbation device via selectively adjusting a volume of fluid within a container arranged inside of the phallic body; and (ii) moving the phallic body of the masturbation device. Steps (i) and (ii) can be controlled via a processor configured to receive data associated with a phallus in media.

The method can further include providing at least one first syringe configured to selectively provide fluid to the container such that rigidity of the phallic body is adjustable based on the volume of fluid within the container.

The method can further include dispensing fluid from at least one opening on the phallic body based on the data associated with the phallus in the media.

The method can further include providing: (i) a first motor associated with the at least one first syringe, (ii) a second motor associated with the at least one second syringe, and (iii) a third motor associated with at least one arm configured to control movement of the phallic body.

As described herein, the present disclosure relates to a device that allows mechanized play with a phallic body during masturbation under control of a computer processor while a related video (or other media) is displayed to a user where the state, movement and actions of the phallic body are related to the state, movement and actions of a phallic body depicted in the video (or other media).

In another example, the system includes a device that allows mechanized play with a phallic body during masturbation under control of a computer processor while a related video (or other media) is displayed to a user where the state, movement and actions of the phallic body are controlled by a remote user.

Other embodiments will be apparent to one skilled in the art.

As disclosed herein, an apparatus and method is provided that allows for synchronization of movements and actions depicted in recorded live media with a phallic masturbation device which mimics the movements, the changing shapes and the actions of related members in displayed media.

Throughout the disclosure, similar elements and components are indicated with similar reference numerals, and otherwise function in the same or similar manner and have the same or similar structures unless otherwise specified herein.

Having thus described the present embodiments in detail, it is to be appreciated and will be apparent to those skilled in the art that many physical changes, only a few of which are exemplified in the detailed description of the embodiments, could be made without altering the inventive concepts and principles embodied therein.

It is also to be appreciated that numerous embodiments incorporating only part of the preferred embodiment are possible which do not alter, with respect to those parts, the inventive concepts and principles embodied therein.

The present embodiment and optional configurations are therefore to be considered in all respects as exemplary and/or illustrative and not restrictive, the scope of the embodiments being indicated by the appended claims rather than by the foregoing description, and all alternate embodiments and changes to this embodiment which come within the meaning and range of equivalency of said claims are therefore to be embraced therein.

What is claimed is:

1. A masturbation device comprising:
a phallic body;
a control assembly configured to control the phallic body; and
a processor configured to control the control assembly and configured to receive data related to movement of a phallus displayed in media;
wherein movement of the phallic body corresponds to movement of the phallus displayed in the media.

2. The masturbation device according to claim 1, wherein the control assembly further comprises:
a container arranged inside of the phallic body that is configured to adjust a rigidity of the phallic body.

3. The masturbation device according to claim 2, wherein the control assembly further comprises at least one first syringe configured to selectively provide fluid to the container such that rigidity of the phallic body is adjustable based on a volume of fluid within the container.

4. The masturbation device according to claim 3, wherein the control assembly further comprises at least one second syringe configured to provide fluid to at least one opening defined on the phallic body.

5. The masturbation device according to claim 4, wherein the control assembly is configured to provide input signals to:
(i) a first motor associated with the at least one first syringe,
(ii) a second motor associated with the at least one second syringe, and
(iii) a third motor associated with at least one arm configured to control movement of the phallic body.

6. The masturbation device according to claim 5, further comprising a housing that surrounds the first motor, the second motor, the third motor, the at least one first syringe, and the at least one second syringe.

7. The masturbation device according to claim 5, further comprising a respective lead screw and nut assembly and a plunger associated with each of the at least one first syringe and the at least one second syringe.

8. The masturbation device according to claim 1, wherein the control assembly is further configured control: (i) rigidity of the phallic body; and (ii) dispensing of fluid from the phallic body.

9. The masturbation device according to claim 1, wherein the data related to movement of the phallus displayed in media is transmitted via a secondary processor to the processor.

10. The masturbation device according to claim 1, wherein the processor is connected to a monitor that is configured to display the phallus.

11. The masturbation device according to claim 1, wherein the phallic body is formed from an elastomeric silicone material.

12. A masturbation device comprising:
a phallic body;
a control assembly configured to control the phallic body; and
a processor configured to control the control assembly, wherein the processor is configured to receive input data from a remote user;
wherein movement of the phallic body corresponds to movement associated with the input data from the remote user, and hardness of the phallic body is adjusted based on the input data.

13. The masturbation device according to claim 12, wherein the control assembly further comprises:
at least one motor configured to control movement of the phallic body;
a container arranged inside of the phallic body that is configured to adjust a rigidity of the phallic body; and
at least one first syringe configured to selectively provide fluid to the container such that rigidity of the phallic body is adjustable based on a volume of fluid within the container.

14. The masturbation device according to claim 13, wherein the control assembly further comprises at least one second syringe configured to provide fluid to at least one opening defined on the phallic body.

15. The masturbation device according to claim 14, wherein the control assembly is configured to provide input signals to:
(i) a first motor associated with the at least one first syringe,
(ii) a second motor associated with the at least one second syringe, and
(iii) a third motor associated with at least one arm configured to control movement of the phallic body.

16. A method of controlling a masturbation device, the method comprising:
(i) adjusting a rigidity of a phallic body of the masturbation device via selectively adjusting a volume of fluid within a container arranged inside of the phallic body; and
(ii) moving the phallic body of the masturbation device;
wherein steps (i) and (ii) are controlled via a processor configured to receive data associated with a phallus in media.

17. The method according to claim 16, further comprising:
providing at least one first syringe configured to selectively provide fluid to the container such that rigidity of the phallic body is adjustable based on the volume of fluid within the container.

18. The method according to claim 17, further comprising:
dispensing fluid from at least one opening on the phallic body based on the data associated with the phallus in the media.

19. The method according to claim 18, wherein dispensing the fluid from the at least one opening on the phallic body is controlled via at least one second syringe.

20. The method according to claim 19, further comprising providing:
(i) a first motor associated with the at least one first syringe,
(ii) a second motor associated with the at least one second syringe, and
(iii) a third motor associated with at least one arm configured to control movement of the phallic body.

21. A system for interaction between users, the system comprising:
a masturbation device including:
a phallic body;
a control assembly configured to control the phallic body; and
a processor configured to control the control assembly and configured to receive data related to at least one of:
(i) a phallus displayed in media, or
(ii) input from a remote user;
wherein the phallic body is configured to be synchronized with the phallus displayed in the media or the input from the remote user.

22. The system according to claim 21, wherein the data from the processor is used to selectively control at least one of:
(i) movement of the phallic body in a reciprocating motion;
(ii) adjusting a rigidity of the phallic body; or
(iii) dispensing fluid from the phallic body.

23. The system according to claim 21, wherein the data from the processor is used to selectively control:
(i) movement of the phallic body in a reciprocating motion;
(ii) adjusting a rigidity of the phallic body; and
(iii) dispensing fluid from the phallic body.

24. The system according to claim 21, wherein the system is configured to provide video communication between a primary user of the masturbation device and the remote user.
